(19) United States
(12) Patent Application Publication
(10) Pub. No.: US 2025/0101250 A1
(43) Pub. Date: Mar. 27, 2025

(54) NON-FLUORINATED SURFACTANTS FOR FLOOR CARE COATINGS

(71) Applicant: BASF SE, Ludwigshafen am Rhein (DE)

(72) Inventors: Anthony MOY, Charlotte, NC (US); Tyrone Anthony VAUGHN, Charlotte, NC (US); Kyle M. FLACK, Charlotte, NC (US); Tony NEELY, Belmont, NC (US)

(21) Appl. No.: 18/832,655

(22) PCT Filed: Jan. 25, 2023
(86) PCT No.: PCT/US2023/011536

§ 371 Date: Jul. 24, 2024

Related U.S. Application Data
(60) Provisional application No. 63/326,975, filed on Apr. 4, 2022.
(60) Provisional application No. 63/303,168, filed on Jan. 26, 2022.

(51) Int. Cl. C09D 133/08; C09D 7/20; C09D 7/63; C09D 7/65

(52) U.S. Cl. CPC C09D 133/08; C09D 7/20; C09D 7/63; C09D 7/65

(57) ABSTRACT

A floor care coating composition comprising a water-based polymer resin, cosolvents, a plasticizer, a defoaming agent, and a non-fluorinated surfactant is disclosed. The aqueous composition is essentially free of fluoropolymers. Methods of coating a surface with the composition are also provided.

### FIELD

This disclosure relates generally to floor care coatings, and more particularly to floor care coating compositions containing non-fluorinated surfactants, and to methods of making and using the surfactants and surfactant-modified floor care compositions.

### BACKGROUND

The use of fluorosurfactants in coatings has increased in recent years due to their performance and efficiency. They provide a variety of desirable performance features in coatings: low surface tension/energy, chemical resistance, etc. In addition. fluorosurfactants tend to be highly efficient, allowing for low usage levels and despite their expense, they present a reasonable cost in use value for the coating formulator.

Over the past decade there has been growing concern in a variety of market segments concerning the use of fluorosurfactants, originating with claims around toxicity of PFOA and PFAS in general. Of recent note, is heightened concern which has been largely driven by anticipated regulatory pressure due to persistency and concerns around health effects of these chemicals.

The chemical persistency of fluorochemicals is due largely to the rather unique nature of fluorine and its ability to form extremely stable compounds. This chemical persistency is further increased with increasing size of the molecules. In recent times, when fluorochemicals became a concern, industries shifted towards development of shorter chain molecules and away from perfluorinated compounds where the fluorine content is maximized per carbon atom, with the expectation that these compounds would have less persistency. Despite these changes, there is still a growing concern as reflected by increasing regulatory inquiry and pressure. One example of this is seen in the US EPA TSCA process where new innovation products containing fluorinated species may be flagged as substances of concern, resulting in SNUR designations, which ultimately pose a significant barrier to acceptance in the commercial market space for such products. Additionally, several states have instituted mandates against fluorosurfactants which will take effect in the coming years. Therefore, there is an increasing need for non-fluorinated surfactant alternatives. This invention addresses this and other needs.

### SUMMARY OF THE DISCLOSURE

Disclosed herein is a floor care coating comprising a water-based polymer resin, cosolvents, plasticizer, defoaming agent, and non-fluorinated wetting agent selected from the group comprising alkoxylated, acrylate, silicone, sulfosuccinate, acetylenic diols, Gemini surfactants, and polymeric surfactants and modifications thereof, as well as blends of such species. Notably, none of the wetting agents are fluorine containing surfactant types. In some embodiments, the floor care coating is applied to polymeric flooring tiles selected from the group comprising vinyl composite tiles, luxury vinyl tiles, or sealed substrates. The application of the coating is done layer-by-layer with 1 to 10, in particular up to 8 layers of coats. The resulting flow and leveling performance including smoothness of film and gloss of the coating system is comparable to the same formulation containing a traditional fluorosurfactant. In addition to gloss and flow and leveling performance, non-fluorinated surfactant alternatives provided in this disclosure demonstrate comparable or improved floor care coating performance in other areas such as chemical, soil, and detergent resistance when compared to traditional fluorosurfactants.

### BRIEF DESCRIPTION OF THE DRAWINGS

FIG. 1 provides an ideal floor care coating application showing good flow and leveling performance with successive layers resulting in smooth even appearance and good gloss.

FIG. 2 provides a non-ideal floor care coating composition with initial layers starting with good flow and leveling performance, but subsequent layers challenged with flow and leveling issues. The propagation of these issues to the final coating appearance results in an apparent texture and lower gloss.

FIG. 3. provides Dynamic Surface Tension (DST) benchmarking at 0.01% surfactant candidate concentration.

FIG. 4 provides Dynamic Surface Tension (DST) benchmarking at 0.1% surfactant candidate concentration.

FIG. 5 provides Dynamic Surface Tension (DST) benchmarking at 0.50% surfactant candidate concentration.

FIG. 6 provides examples of 5 layer floor care coating applications on a VCT substrate.

FIG. 7 provides gloss measurements of selected surfactant candidates for floor care coating applications on VCT.

FIGS. 8a, 8b, and 8c provide chemical resistance, soil resistance, and detergent resistance measurements for a variety of surfactants in comparison to the fluorosurfactant control.

FIGS. 9a and 9b provide photos of the best surfactant candidates.

FIG. 10 provides gloss measurements of the best surfactant candidates for floor care coating applications on VCT.

FIG. 11 provides photos of selected best surfactant candidates for floor squeegee applications.

FIG. 12 provides photos of selected best surfactant candidates for floor squeegee applications on an alternate substrate (Armstrong Premium Excelon® 56790 Black VCT).

FIG. 13 provides the Orchard equation.

### DETAILED DESCRIPTION

### I. Floor Care Coating Compositions

Fluorine technology brings a variety of highly desirable performance attributes ranging from wetting of difficult substrates due to the ability to efficiently reduce surface tension of a coating to providing easy to clean attributes derived from extreme chemical inertness combined with very low surface energy.

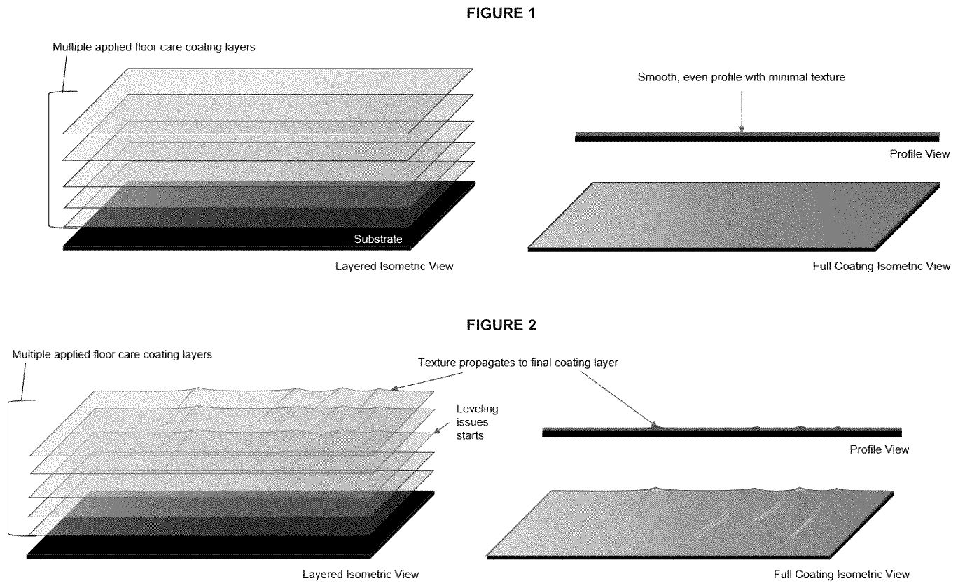

For the floor care coatings market, fluorosurfactants provide a strong flow and leveling effect. This is particularly important as these coatings are typically applied layer-by-layer over a low energy substrate. Here, the surfactant ideally provides sufficient lowering of surface tension in the coating to enable the first layer to initially wet out the substrate and then for each successive layer to wet out the previous layer as well. All this should be achieved while providing good leveling characteristics so that minimal texture is developed during the floor care application process. The goal is to have a smooth, relatively defect free surface, as shown in FIG. 1. In addition, the coating preferably does not have a significant slip component. This is important from a safety perspective as the coatings will ultimately see pedestrian foot traffic.

In a non-ideal application, the coating will typically exhibit insufficient leveling performance at some intermediate layer which is then propagated with subsequent layer application. This may be further complicated with additional sites of insufficient leveling occurring during the process as layers are built up. See FIG. 2. In the end, the result is a coating application which shows unacceptable surface texture or lack of smoothness. The gloss may also be impacted.

Initial layers start with good flow and leveling performance. Subsequent layers are challenged with flow and leveling issues which propagate to final coating appearance. Texture is apparent and gloss may be lower.

Decreasing surface energy with each successive layer application may contribute to this propagation of texture. If this were true, it would potentially impact the leveling effect, resulting in longer times required for the leveling process to complete in each layer. This would be subject to evaporation and curing which may occur on a faster timeline. Hence, the incomplete leveling of the coating would be locked in.

Therefore, it is an objective of the present invention to provide a floor care coating that has good flow and leveling performance through multiple layers. Given concerns about persistency and health, it is also an objective of the present invention to provide a surfactant which is not of a potentially regulated class. In addition to environmental sustainability, advantages have also been seen in chemical resistance, soil resistance, and detergent gloss retention.

The floor care coatings disclosed herein comprise water-based polymer resin, cosolvents, plasticizer, defoaming agent, and non-fluorinated wetting agent selected from the group comprising alkoxylated, acrylate, silicone, sulfosuccinate, acetylenic diols, Gemini surfactants, and polymeric surfactants and modifications thereof, as well as blends of such species.

The floor care coatings contain at least one water-based polymer resin. These polymer resins can be emulsion polymers formed from ethylenically unsaturated monomers. The preparation of emulsion polymers is well known to those skilled in the art. Generally, such emulsion polymers are prepared with ethylenically unsaturated monomers, initiators, surfactants, or polymeric emulsifying agents and water.

The film forming polymers are typically acrylic polymers, acrylic copolymers, styrene-acrylic copolymers, or blends thereof. Acrylic polymers contain only one type of acrylate monomer whereas the acrylic copolymers comprise two or more different types of acrylate monomers. Styrene-acrylic copolymers comprise at least one type of styrene monomer and one type of acrylate monomer. The acrylate monomers include for example acrylic acid, butyl acrylate, ethyl acrylate, methyl acrylate, 2-ethyl hexyl acrylate, acry-Ionitrile, acrylamide, methacrylic acid, methyl methacrylate, ethyl methacrylate, butyl methacrylate, methacrylamide, and the like. Styrene monomers include styrene, alpha-methyl styrene, and the like.

Acrylic polymers suitable as film-forming polymers include, for example, DURAPLUS 2 or DURAPLUS 3 modified acrylic floor polishes commercially available from Rohm and Haas Philadelphia, Pa. Other commercially available acrylic polymers or copolymers include MEGATRON 240, MEGATRON 228 or SYNTRAN 1921 from Interpolymer, Canton, Mass.

Examples of commercially available styrene-acrylic copolymers include, styrene/methyl methacrylate/butyl acrylate/methacrylic acid (S/MMA/BA/MAA) copolymers, styrene/methyl methacrylate/butyl acrylate/acrylic acid (S/MMA/BA/AA) copolymers, and the like, S/MMA/BA/MAA and S/MMA/BA/AA copolymers such as MOR-GLO-2 commercially available from OMNOVA Solutions, Inc. of Chester, S.C.

The aqueous coating composition typically contains between about 5 and 70 wt. % or even between about 20 and 60 wt. % film-forming polymers based on the weight of the aqueous coating composition.

In some embodiments, the floor care coatings contain a hydrophilic cosolvent. These water-soluble organic solvents may optionally be combined with the distilled water in the dispersion, for example, to facilitate uniform drying and or film-formation. Suitable hydrophilic cosolvents include methanol, ethanol, isopropanol, and isobutanol; amides and lactams such as, for example, N, N-dimethylformamide, N,N-dimethylacetamide, and N-methylpyrrolidone; ketones and ketoalcohols such as, for example, acetone, cyclohexanone, methyl isobutyl ketone, diacetone alcohol; ethers such as, for example, tetrahydrofuran, dioxane, and lower alkyl ethers of polyhydric alcohol such as ethylene glycol monomethyl (or monoethyl) ether, diethyl-ene glycol methyl (or ethyl) ether, and triethylene glycol monomethyl (or monoethyl) ether; alkylene glycols and polyalkylene glycols such as, for example, ethylene glycol, propylene glycol, butylene glycol, triethylene glycol, hexylene glycol, diethylene glycol, polyethylene glycol, polypropylene glycol; 1,3-dimethyl-2-imidazolidinone; and combinations thereof.

The aqueous coating composition typically contains between about 1 and 20 wt. % hydrophilic cosolvent or even about 5 to 10 wt. % hydrophilic cosolvent based on the weight of the aqueous coating composition.

In some embodiments, the floor care coatings contain a plasticizer to improve its ductility and flexibility. The plasticizer also helps facilitate film formation at ambient temperatures when the coating is applied to a substrate. Suitable plasticizers include organophosphate plasticizers such as tricresyl (methyl phenyl) phosphate (TCP), 2-ethylhexyldiphenyl phosphate, and tri-2-ethylhexyl phosphate. Suitable plasticizers also include ester plasticizers such as diisobutyl phthalate (DIBP), di-n-butyl phthalate (DBP), butyl benzyl phthalate (BBzP), bis(2-ethylhexyl) phthalate (DEHP), diisononyl phthalate (DINP), bis(2-propylheptyl) phthalate (DPHP), diisodecyl phthalate (DIDP), diisoundecyl phthalate (DIUP), and ditridecyl phthalate (DTDP).

The aqueous coating composition typically contains between about 1 and 10 wt. % plasticizer or even from about 2 to 5 wt. % plasticizer based on the weight of the aqueous coating composition.

In some embodiments, the floor care coatings contain a defoaming agent to help inhibit defects caused by foaming. Defoamers may be selected from commonly used water-based defoamers, silicone-based defoamers, or alklpolyacrylates that are known to one skilled in the art. Examples of such defoamers include hydrocarbon based defoamers such as SURFYNOL MD-20 commercially available from Air Products and Chemicals, Allentown, Pa. In other embodiments it may be desirable to add a defoamer that contains silicone such as SE-21 commercially available from Wacker Chemical Corporation.

The aqueous coating composition typically contains between 0.001 wt. % and 5% of defoamer or even 0.01 wt. % to about 3 wt. % based on the weight of the aqueous coating.

In some embodiments, the floor care coatings contain a non-fluorinated wetting agent selected from the group consisting of alkoxylated, acrylate, silicone, sulfosuccinate, acetylenic diols, and polymeric surfactants and modifications thereof, as well as blends of such species.

TABLE 1
Summary of non-fluorinated surfactants selected for evaluation.

| Chemistry | General Structure | Value |
|---|---|---|
| Alkoxylate | 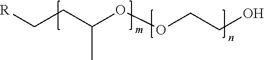 | Low foaming; excellent dynamic surface tension reduction |
| Sulfosuccinate | 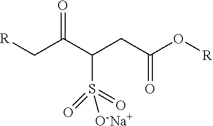 | High efficiency wetting agent; excellent dynamic surface tension reduction |
| Hyperbranched Polymer 1 Hyperbranched Polymer 2 | [symbol] | Anti-foam, wetting and leveling agent; higher hydrophobic content Anti-foam, wetting and leveling agent |
| Modified Alkoxylate | Proprietary Composition | Anti-foam, wetting and leveling agent |
| Modified Silicone 1 | Proprietary Composition | Anti-foam, wetting agent; excellent |
| (no slip) | | compatibility; no slip |
| Sulfosuccinate/ Hyperbranched Polymer Blend | 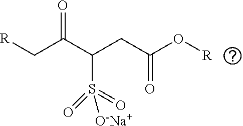 | Excellent dynamic surface tension reduction with anti-foam |
| Sulfosuccinate/ Mod. Alkoxylate* Blend | 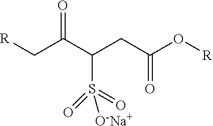 * Proprietary composition | Excellent dynamic surface tension reduction with anti-foam |
| Modified Silicone 2 (slip) | [symbol] | Excellent wetting, flow, leveling with low surface energy (slip, anti-mar) |
| Gemini Surfactant | [symbol] | Anti-foam, wetting and leveling agent |

[symbol]

indicates data missing or illegible when filed

R, R′, R¹, R², R³ shown in the structures in Table 1 are organic species which can be composed of aliphatic or branched C₁-C₂₀ carbon chains or more preferably C₁-C₅ carbon chains. These chains may be saturated or unsaturated, and optionally may include additional modifications or functionality including alkoxy, hydroxyl, amine, epoxide, and cyclic or aromatic species.

The selection of the non-fluorinated surfactants was done based on their proven wetting performance in general aqueous coatings applications. Blends were chosen to examine potential synergistic effects. For example, sulfosuccinates are known to be subject to foam development issues. Perhaps pairing another surfactant with antifoam characteristics would enable control over this aspect. Lastly, a modified silicone with slip characteristics was included as an unusual variant, especially in light of the need to avoid slip. Perhaps there may be an optimal point in dosing of such a surfactant where slip would not be a factor, while benefiting from the wetting and leveling performance that it could bring to the coating.

The aqueous coating composition typically contains between 1 to 15 wt. % non-fluorinated wetting agent, or even about 3 wt. % to 10 wt. % non-fluorinated wetting agent.

The aqueous coating compositions can also contain other components such as polyvalent metal compounds, alkali soluble resins, waxes, couplers, perfumes, thickeners, colorants, and biocides. Some embodiments may also contain particles.

The waxes or mixtures of waxes that can be used include waxes of a vegetable, animal, synthetic, and/or mineral origin. Representative waxes include, for example, carnuba, candelilla, lanolin, stearin, beeswax, oxidized polyethylene wax, polyethylene emulsions, polypropylene, copolymers of ethylene and acrylic esters, hydrogenated coconut oil or soybean oil, and the mineral waxes such as paraffin or ceresin. The waxes typically range from 0 to about 15 wt. % or from about 2 to about 10 wt. % based on the weight of the aqueous coating composition.

Another aspect of the present disclosure provides a method for applying the aqueous coating compositions to surfaces. The compositions may be applied with a mop, sponge, roller, cloth, brush, pad or any other suitable tools such as T-bar applicators, application dispensing tools or spray application equipment. The compositions can be applied to a variety of substrates including floor, wall, furniture, window, countertop and bathroom surfaces. The substrates can be fibers, metal, plastic, wood, stone, brick, glass, cement, concrete, ceramic, Masonite, dry wall, plaster, plastic, and the like. In one embodiment, the substrate is a floor surface. The floor surface can be wood, composite vinyl tile, vinyl, linoleum, asphalt, asbestos, concrete, ceramic, and the like. In a particular embodiment, the floor surface is a polymeric flooring tile, typically a vinyl composite tile or a luxury vinyl tile.

Typically, after the aqueous coating composition is applied to a surface it is permitted to dry to form a surface with a coating. The coating may comprise a single layer or multiple layers. Multiple layers may be achieved by applying multiple coatings of the aqueous coating composition. The multiple coatings may be applied immediately or after the coating has dried. In some embodiments, the coating comprises 2, 3, 4 or more layers. In a preferred embodiment, the coating comprises 8 layers. Each coat may be applied in the same way or different techniques may be used to apply each coat.

In any of the aforementioned embodiments of aqueous composition and any of the aforementioned embodiments of articles according to the present invention, the surfactants can be used individually or in combination with a non-fluorinated surfactant (e.g., a hydrocarbon or silicone surfactant) to produce the desired surface tension reduction or wetting improvement.

### II. Performance of Floor Care Coating Compositions

The floor care coating compositions as disclosed herein may demonstrate comparable or improved properties in gloss, flow, leveling, chemical resistance, soil resistance, and detergent resistance in comparison to a fluorosurfactant control.

For example, when applied to a substrate, the coating compositions disclosed herein may demonstrate a gloss measurement of 64 GU or greater, 66 GU or greater, 68 GU or greater, 70 GU or greater, 72 GU or greater, 74 GU or greater, 76 GU or greater, 78 GU or greater, or 80 GU or greater when measured at an angle of 20°.

When applied to a substrate, the coating compositions disclosed herein may demonstrate a gloss measurement of 84 GU or greater, 86 GU or greater, 88 GU or greater, 90 GU or greater, or 92 GU or greater when measured at an angle of 60°.

When applied to a substrate, the coating compositions disclosed herein may demonstrate a chemical resistance rating against hand sanitizer of 2 or more, 3 or more, 4 or more, or 5 or more.

When applied to a substrate, the coating compositions disclosed herein may demonstrate a chemical resistance rating against a quat cleaner of 3 or more, 4 or more, or 4 or more.

When applied to a substrate, the coating compositions disclosed herein may demonstrate a chemical resistance rating against a neutral cleaner of 4 or more or 5 or more.

When applied to a substrate, the coating compositions disclosed herein may demonstrate a soil resistance of 10 dE or greater, 12 dE or greater, 14 dE or greater, 16 dE or greater, or 18 dE or greater.

When applied to a substrate, the coating compositions disclosed herein may demonstrate improved detergent resistance as measured by gloss retention after 1 or 7 days of exposure. The coating compositions as disclosed herein may have a gloss retention of 55% or greater, 60% or greater, 65% or greater, 70% or greater, 75% or greater, 80% or greater, 85% or greater, or 90% or greater after 1 day or exposure. The coating compositions as disclosed herein may have a gloss retention of 65% or greater, 70% or greater, 75% or greater, 80% or greater, 85% or greater, or 90% or greater after 7 days of exposure.

When applied to a substrate, the coating compositions disclosed herein may demonstrate flow and levelling performance comparable or better than the fluorosurfactant control. As measured by visual rating scale of 1-10, a comparable or better ranking equates to a rating of 8-10, with a 9 rating being equal to the fluorosurfactant case. The coating compositions of the present disclosure may demonstrate a flow and levelling performance of 8 or greater, 9 or greater, or 10.

The following examples are for illustrative purposes only and are not meant to limit the scope of the claims. All parts, percentages, ratios, etc. in the examples and the rest of the specification are by weight, unless noted otherwise

### EXAMPLES

### I. Durable High Gloss Floor Coating Formulation

TABLE 2
Mass balance of the durable high gloss floor coating.

| | Amount |
|---|---|
| Materials | (wt. %) |
| DI Water | 32.39 |
| Surfactant Solution (1% Active) | 6.61 |
| Hydrophilic Cosolvent | 5.89 |
| Ester Plasticizer | 1.43 |
| Phosphate Plasticizer | 2.62 |
| Acrylic Emulsion | 45.43 |
| PE Wax Emulsion | 5.62 |
| Defoamer | 0.01 |
| Total | 100.00 |

Each of the ingredients in Table 2 above were added under agitation to form the floor coating formulation. By simple adjustment of the surfactant addition, examination of the effects of surfactant concentration could be made. For a control benchmark, the same formulation was used with a commercial fluorosurfactant that is commonly used in floor care coatings, with an active content loading of 0.01%.

### II. Evaluation of Wetting Agents Vs. Fluorosurfactant by Surface Tension Comparison

As surface tension is believed to be a critical factor in enabling the wetting performance of a coating, the surfactant candidates were benchmarked against the fluorosurfactant in the floor care coating formulation using Dynamic Surface Tension (DST) methodology. The benchmarking was done comparing the control formulation with 0.01% fluorosurfactant against the surfactant candidates at three concentration levels to scout the performance space: 0.01%, 0.10% and 0.50%.

DST provides a useful measure of not only the static surface tension, but also a measure of the stability of the solution surface tension under more dynamic situations. Typically, all surfactants will produce a reduction in surface tension where, at zero bubble frequency, the magnitude is equal to what is typically known as the static surface tension. As bubble frequency increases and the solution becomes more turbulent, the surface tension will tend to rise. The premise that each surfactant at a given concentration will yield a characteristic DST curve serves as a good basis for comparison of the ability of different surfactants to suppress surface tension in a coating solution and the degree of surface tension stability provided by each.

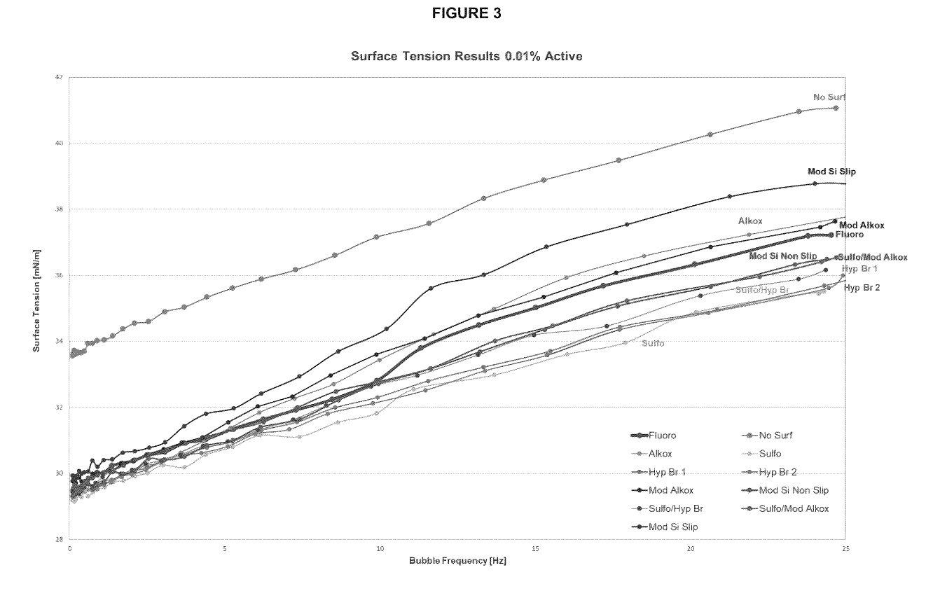

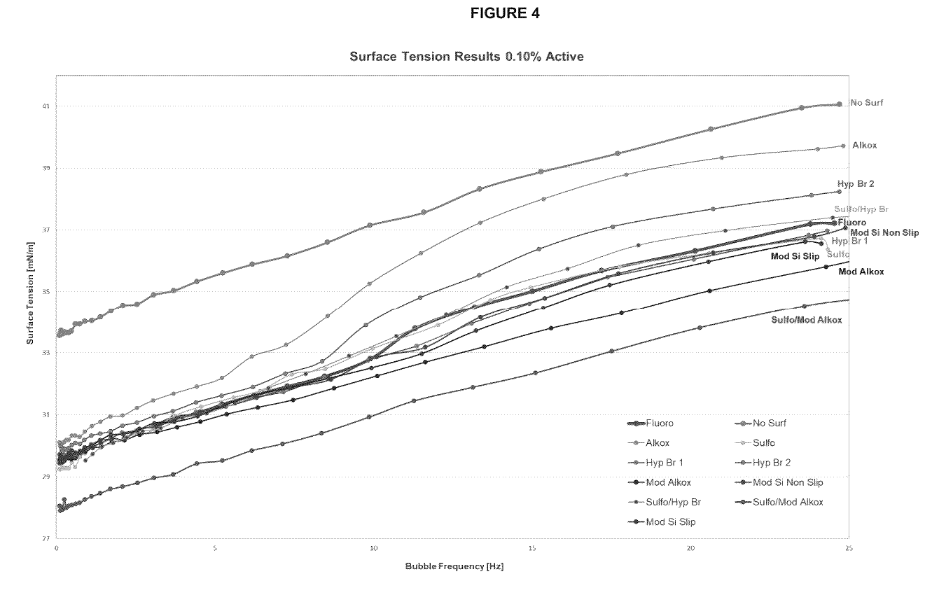

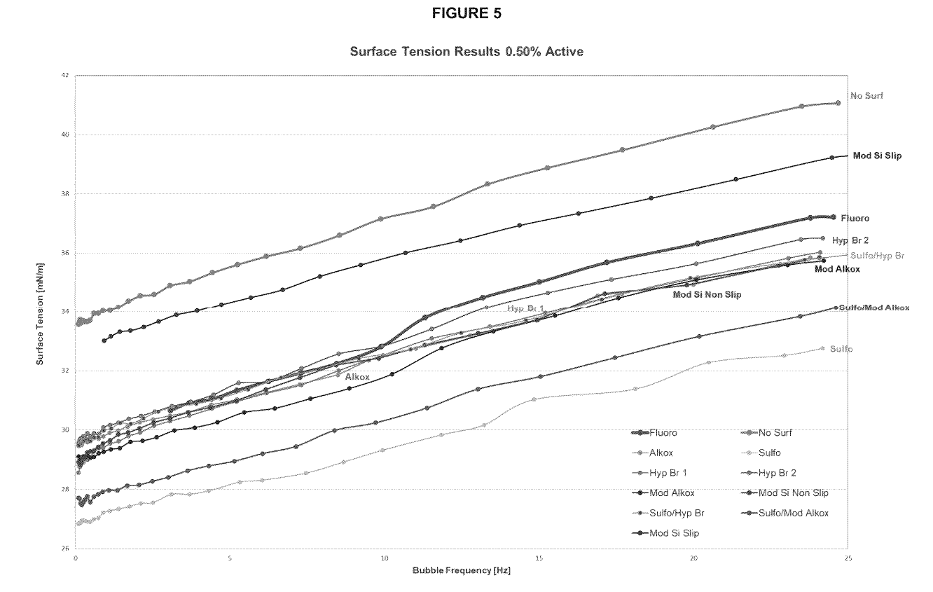

FIGS. 3, 4, and 5 provide comparisons of 0.01% fluorosurfactant to the surfactant candidates at 0.01%, 0.10%, and 0.50% respectively.

In the evaluation of the DST data concerning the various surfactant candidates, the focus was to determine those surfactants, at given concentrations, that provided both of the following performance features when compared to the fluorosurfactant:
1. Equal or lower static surface tension
2. Equal or better surface tension stability under dynamic conditions

Depending on the concentration level, a variety of surfactant candidates met these criteria. The general findings of this work are summarized in Table 3 below.

TABLE 3
Summary of DST performance benchmarking

| | Dosing Level |
|---|---|
| | to Meet Surface |
| Surfactant type | Tension Criteria |
| Alkoxylate | High |
| Sulfosuccinate | Low, Mid, High |
| Hyperbranched Polymer 1 | Low |
| Hyperbranched Polymer 2 | Low |
| Modified Alkoxylate | Mid, High |
| Modified Silicone 1 (no slip) | Low, Mid, High |
| Sulfosuccinate/Hyperbranched Polymer | Low, High |
| Blend | |
| Sulfosuccinate/Mod. Alkoxylate Blend | Low, Mid, High |
| Modified Silicone 2 (slip) | Mid |

As seen in the results in Table 3, the sulfosuccinate, modified silicone (no slip), and the sulfosuccinate/modified alkoxylate blend were the most versatile for surface tension suppression and dynamic stability.

### III. Application Testing Results

From the DST work done above, promising candidates were then evaluated in a floor care coating application at lab scale. For the lab scale floor care application, Armstrong® Standard Excelon® Imperial Texture 51910021 C132B vinyl composite tile (VCT) was used as the substrate. Cheese cloth saturated with a given amount coating formulation was used to apply the coating onto the VCT substrate in a systematic fashion which covered vertical, horizontal, and diagonal directions. The coating layer would be allowed to dry until it was no longer tacky to the touch. This typically took 30 minutes, depending on humidity and temperature conditions.

For the evaluation, the target was to apply 5 coating layers of floor care formulation. Gloss measurements were done after each coating layer. Final evaluation of the coatings was done by visual assessment, comparing to the fluorosurfactant control.

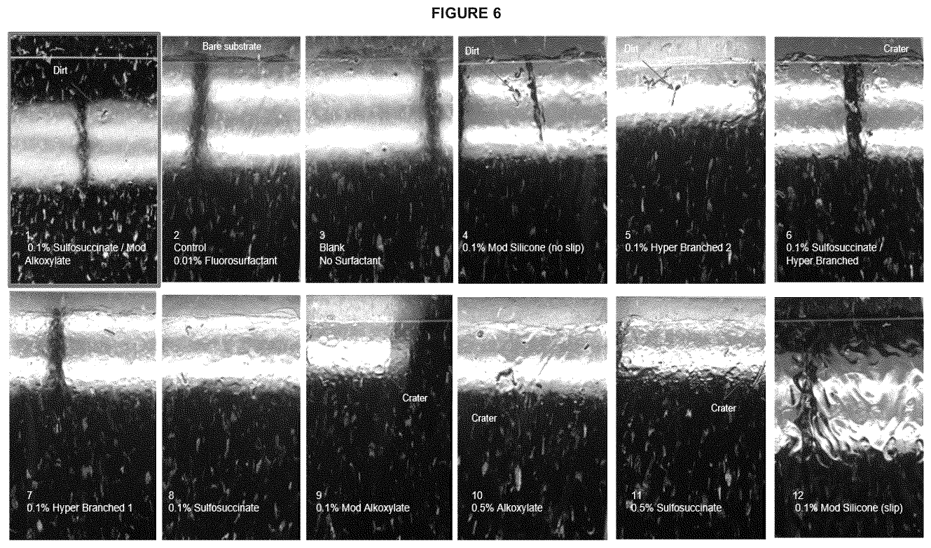

In FIG. 6, photos documenting selected coatings applications with given surfactants are shown. A selection of coatings from an early experimental application set are shown, with visual rankings (1=best; 12=worst). Included for comparison are the coating formulation containing fluorosurfactant and a blank formulation containing no surfactants. Here the formulation containing 0.1% of a sulfosuccinate and modified alkoxylate surfactant blend provided the best overall coating experience, approaching the appearance of the fluorosurfactant control. Criteria which went into the rating of each coating included: leveling (smooth film appearance), presence of craters, and unusual flow formations. Note that some artifacts seen in some of the photos are actually fiber remnants from the cheese cloth which were deposited during application of the coating. These did not factor into the visual assessment. In addition, the visual assessment was done by more than one person to normalize the assessment result and reduce the effect of individual bias.

Some interesting observations were obtained during review of the results shown in FIG. 6.

Concentration is an important factor. In the case of the sulfosuccinate, concentration levels of 0.1% and 0.5% are shown in FIG. 6 in panels 8 and 11, respectively. It is seen with increasing concentration that the amount of surface defects increases. Here, using less surfactant yields a more defect free coating. This has been seen with other surfactant cases as well.

Surface defects and signs of leveling issues typically are not evident in initial layers. As layer count increases, at some point one or both issues appear to varying degrees, depending on the surfactant type and its concentration in the formula.

One surfactant type, the modified silicone with slip function proved to be an unsuitable choice for the floor care coating application at all levels examined. This is seen in panel 12, where unusual swirl patterns are evident.

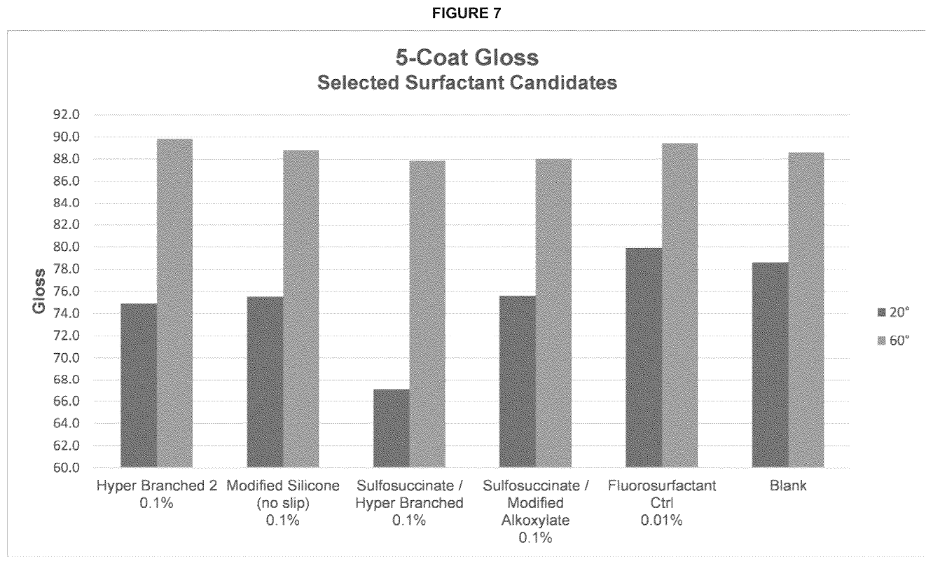

Gloss measurements for the top row of applications in FIG. 6 are presented in FIG. 7. Here, all the surfactant candidates yielded lower 20° gloss as compared to the fluorosurfactant. Several of the candidates had 60° gloss readings that came close to that of the fluorosurfactant, with one that exceeded it.

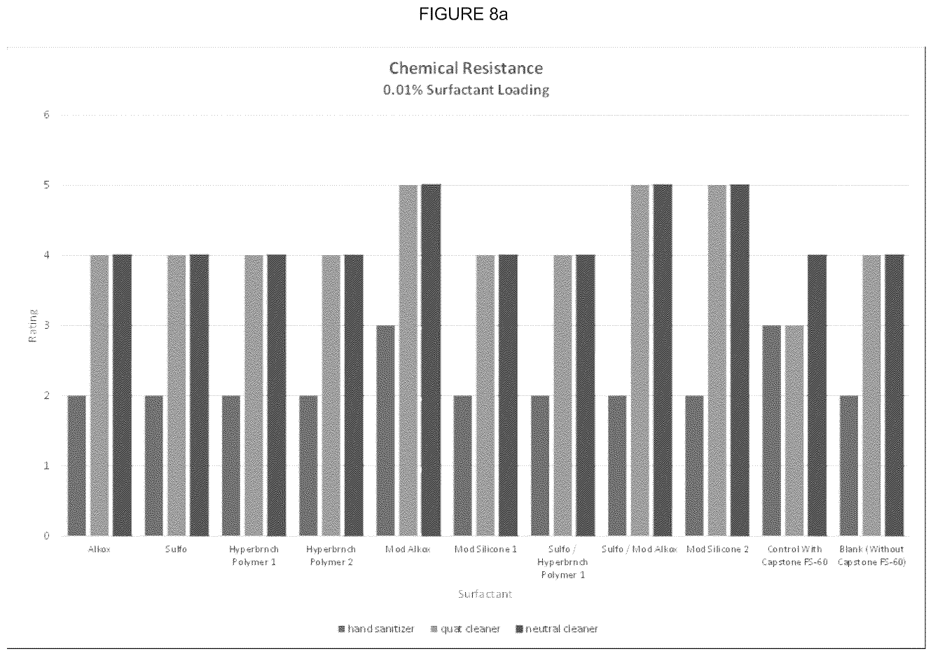

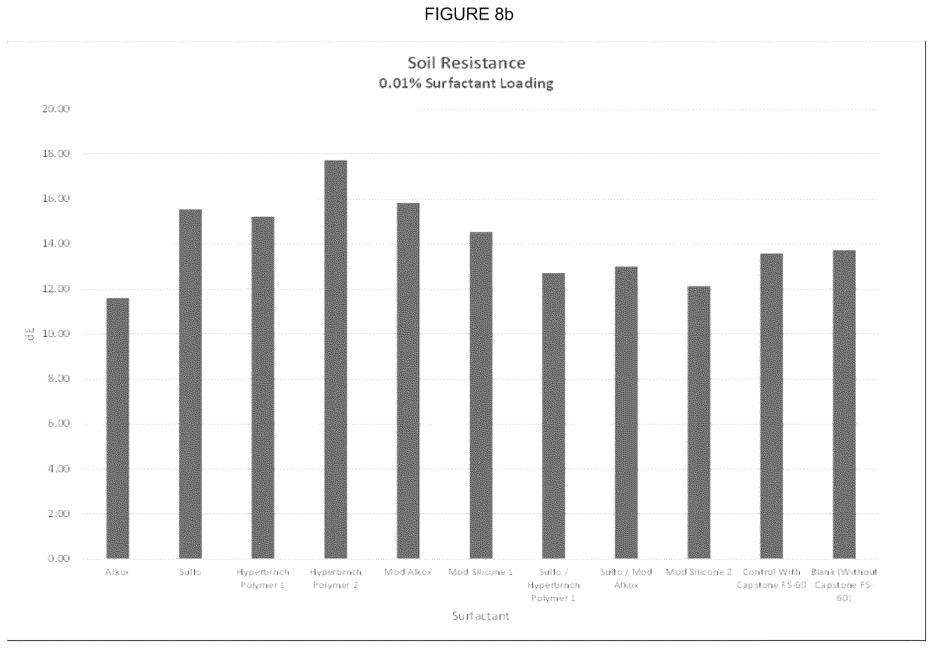

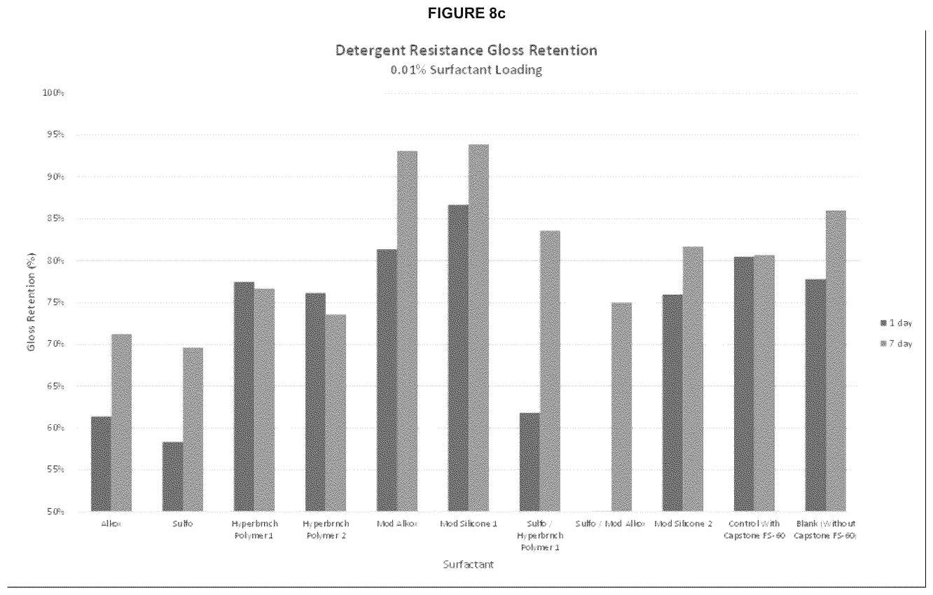

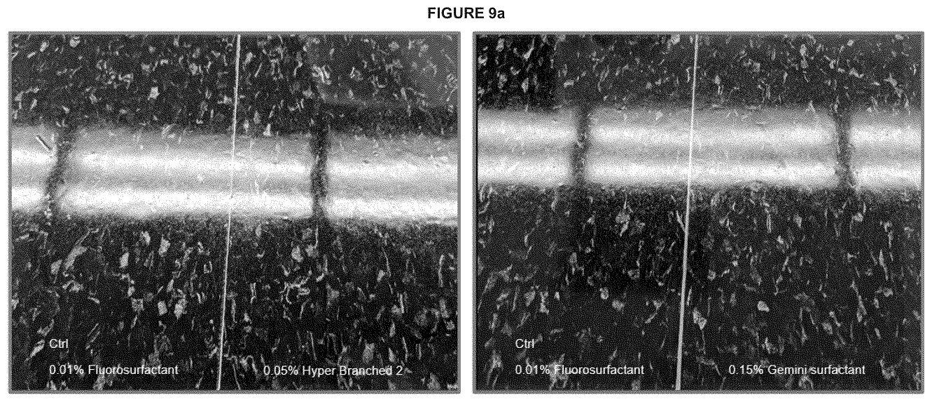

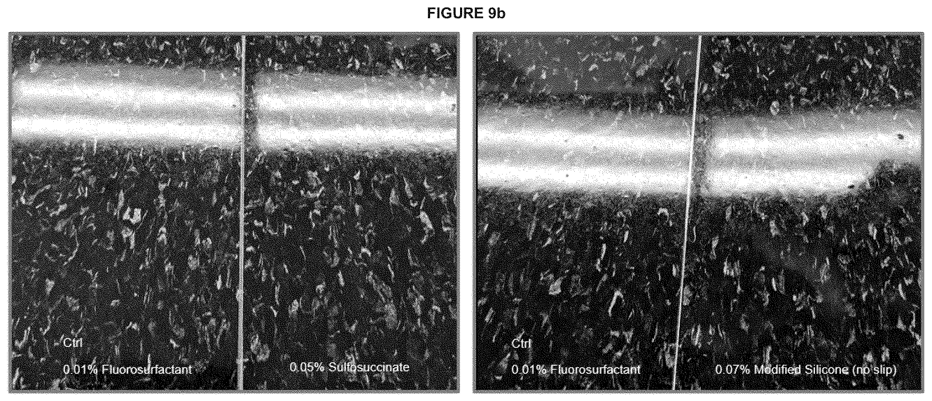

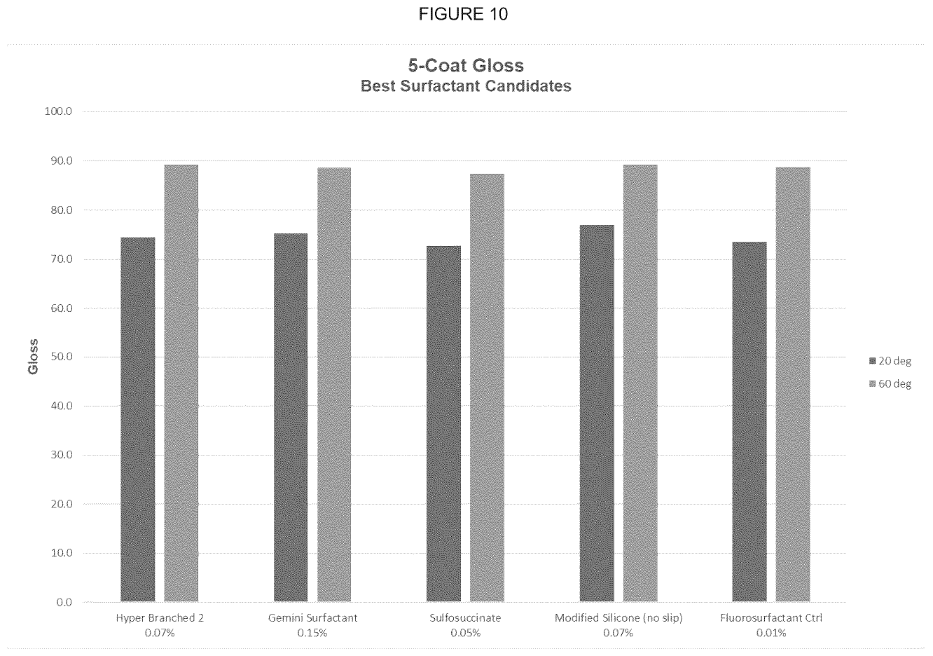

Additional performance characteristics such as chemical resistance, soil resistance, and detergent resistance were measured, comparing a variety of surfactants to the fluorosurfactant control. FIG. 9a documents chemical resistance using 3 different chemical cleaning agents, with surfactants at 0.01% concentration. Here, a modified alkoxylate surfactant demonstrated advantageous chemical resistance with all three agents over the performance of the fluorosurfactant. In FIG. 9b, an alkoxylate, a sulfosuccinate/hyperbranched polymer blend, a sulfosuccinate/modified alkoxylate blend, and a modified silicone demonstrated better dirt resistance as shown by lower dE (color change) relative to the fluorosurfactant control. Inn FIG. 8c, a modified alkoxylate, and modified silicone demonstrated better gloss retention versus the fluorosurfactant when exposed to detergent, initially and after 1 week.

Moving forward, a variety of iterations around the concentration of surfactants were completed to optimize coating performance. In addition, a new surfactant type, a Gemini surfactant, was also included in the evaluation. From this process, four candidates were selected as having the best overall performance relative to the fluorosurfactant control. Photos of these surfactants and their concentrations are shown in FIGS. 9a and 9b. Note in each photo that the VCT panel has one half applied with the fluorosurfactant formulation (left side) and the other half with the surfactant candidate formulation (right side). This allows for easy comparison of the candidates to the control, while eliminating experimental variables of substrate panel differences, application time, coating cure time, etc.

For the best surfactant candidates, the gloss measurements proved to be similar at both 20° and 60° relative to the fluorosurfactant control, shown in FIG. 9.

### IV. Application of Floor Care Coatings to Vinyl Tiles

The best candidates were chosen for simulated “real world” flooring application done using a squeegee. The following candidates were chosen for evaluation: 0.01% Fluorosurfactant Control, 0.1% Sulfosuccinate/Modified Alkoxylate blend (from initial work), 0.07% Hyper Branched 2, 0.07% Modified Silicone (no slip).

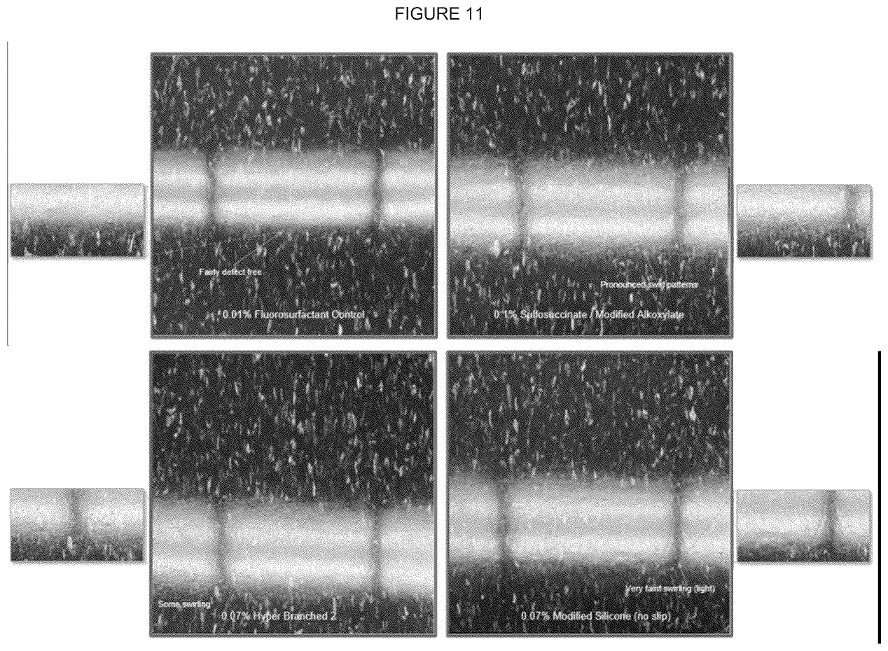

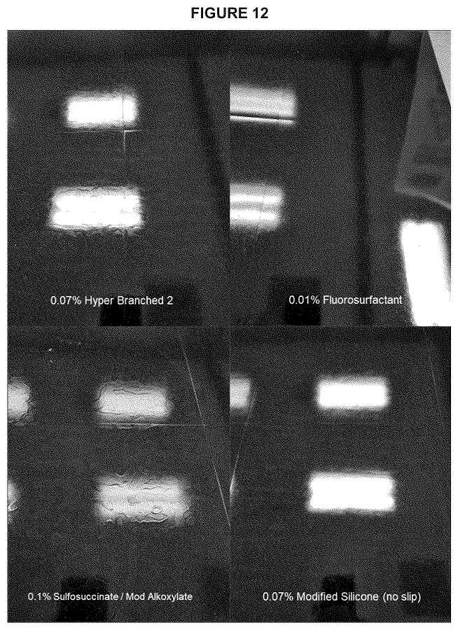

Here, sufficient floor care coating was used to saturate a squeegee mop head and the coating was then applied in vertical and horizontal passes to ensure uniform coverage of the substrate. So as to maintain consistent substrate, panels of Armstrong® Standard Excelon® Imperial Texture 51910021 C132B vinyl composite tile used in lab application were taped to a test floor which had been masked off. The results of the squeegee flooring application are shown below in FIG. 11.

In the squeegee application of the various floor coatings, it was noted that some of the candidates left more of a texture in the coating than they had displayed when using cheese cloth. Most notable was the 0.1% Sulfosuccinate/Modified Alkoxylate where there were significant swirl patterns evident in the coating. To a lesser degree the 0.07% Hyper Branched 2 surfactant also showed some of this phenomenon. The 0.07% Modified Silicone (no slip) surfactant yielded the smoothest appearance of the surfactant candidates chosen and closest in performance to the fluorosurfactant control which had the overall best appearance.

From this, it is apparent that there are resulting coating performance may shift when going from cheese cloth (lab) to squeegee (real world) application.

The performance of some of the best coating formulations were also applied to an actual test floor composed of a different substrate (Armstrong Premium Excelon® 56790 Black VCT). Here, the 0.01% Fluorosurfactant formulation proved to be the best with a few very faint lap lines evident from the squeegee application. The 0.07% Modified Silicone (no slip) formulation was the next best performer, displaying some signs of very light lap lines. The other two candidates proved to have significant wetting and leveling issues with the black VCT substrate. In general, the order of performance for flow and leveling remained the same across the surfactant candidates. However, shortcomings in performance were more magnified when using the black VCT substrate. Further formulation optimization work is planned to account for this more “difficult” substrate.

### V. Relationship Between Surface Tension and Layer-by-Layer Coating Application

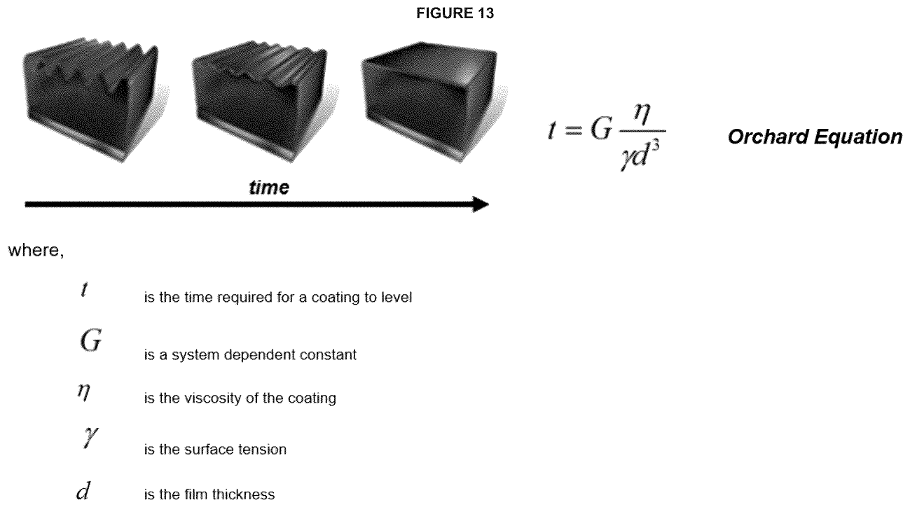

One of the hypothetical premises that is assumed in the layer-by-layer application of floor care coatings is that the surface tension is potentially dropping with each layer that is applied, in turn making it more difficult for each layer to fully level. This is reflected in the Orchard Equation, provided in FIG. 13, which relates the time for leveling in a coating to various parameters such as surface tension, viscosity, and film thickness.

The Orchard equation implies that as surface tension decreases, leveling takes longer. To examine the layer-by-layer application in this context, surface energy measurements were made after each layer during a floor care coating experiment, allowing for a minimum of 30 minutes for curing to a non-tacky state. Surface energy was measured using a Krüss Mobile Surface Analyzer (MSA).

The results of the study are shown in FIG. 11. Two break periods were instituted between layers 2, 3 and 4, 5. The break period between layers 2,3 was particularly long. Upon returning after the break period, the surface energy was remeasured for the last coating before a new layer was applied. This provided for a time delay between repeats to study the behavior of the surface energy.

For the first two layers, the surface energy dropped. Then for the remaining layers, out to layer 7, the surface energy appeared to increase. With each break the surface energy dropped. A possible explanation for this phenomenon is that the coating continues to cure over time with water (a high surface tension) component leaving the film, thus resulting in a drop in surface energy when remeasured at a later point in time. It is also noted that the amount of surface energy drop for the two break periods is not to the same degree. This can be explained by possible differences in the humidity and temperature of the lab during the different break periods. Nevertheless, within the time frame of the coating applications (typically 30 mins when no break periods are instituted), the surface energy of each successive layer tends to increase.

1-26. (canceled)

27. A floor care coating useful as a coating on polymeric flooring tiles comprising:
a water-based polymer resin,
one or more cosolvents,
a plasticizer,
a defoaming agent, and
a non-fluorinated surfactant.

28. The composition as claimed in claim 27, wherein the water-based polymer resin is selected from the group consisting of acrylic polymers, acrylic copolymers, styrene-acrylic copolymers, and blends thereof.

29. The composition as claimed in claim 28, wherein the water-based polymer resin is present in an amount of 5-70 wt. % based on the weight of the floor care coating composition.

30. The composition as claimed in claim 27, wherein the one or more cosolvents is selected from the group consisting of distilled water, methanol, ethanol, isopropanol, isobutanol, N,N-dimethylformamide, N,N-dimethylacetamide, N-methylpyrrolidone, acetone, cyclohexanone, methyl isobutyl ketone, diacetone alcohol, tetrahydrofuran, dioxane, ethylene glycol, monomethyl ether, ethylene glycol monoethyl ether, diethylene glycol methyl ether, diethylene glycol ethyl ether, triethylene glycol monomethyl ether, triethylene glycol monoethyl ether, ethylene glycol, propylene glycol, butylene glycol, triethylene glycol, hexylene glycol, diethylene glycol, polyethylene glycol, polypropylene glycol and 1,3-dimethyl-2-imidazolidinone.

31. The composition as claimed in claim 30, wherein the one or more cosolvents is present in an amount of 1-20 wt. % based on the weight of the floor care coating composition.

32. The composition as claimed in claim 27, wherein the plasticizer is selected from the group consisting of organophosphate plasticizers, ester plasticizers, and diisobutyl phthalate.

33. The composition as claimed in claim 32, wherein the plasticizer is present in an amount of 1-10 wt. % based on the weight of the floor care coating composition.

34. The composition as claimed in claim 27, wherein the defoaming agent is selected from the group consisting of water-based defoaming agents, silicone-based defoaming agents, and alkylpolyacrylates.

35. The composition as claimed in claim 34, wherein the defoaming agent is present in an amount of 0.001-5 wt. % based on the weight of the floor care coating composition.

36. The composition as claimed in claim 27, wherein the non-fluorinated surfactant is selected from the group consisting of alkoxylated, acrylate, silicone, sulfosuccinate, acetylenic diols, Gemini surfactants, polymeric surfactants, and mixtures thereof.

37. The composition as claimed in claim 36, wherein the non-fluorinated surfactant is present in an amount of 1-15 wt. % based on the weight of the floor care coating composition.

38. The composition as claimed in claim 27, wherein the polymeric flooring tiles are selected from the group consisting of vinyl composite tiles and luxury vinyl tiles.

39. A method for applying the floor care coating of claim 27 to polymeric flooring tiles, wherein the floor care coating is applied in multiple layers to the flooring tiles.

40. A substrate coated with the composition of claim 27, wherein the substrate is selected from the group consisting of vinyl composite tiles and vinyl luxury tiles.

41. The coated substrate of claim 40, wherein the coating demonstrates a gloss measurement of 64 GU or greater when measured at an angle of 20°.

42. The coated substrate of claim 40, wherein the coating demonstrates a gloss measurement of 84 GU or greater when measured at an angle of 60°.

43. The coated substrate of claim 40, wherein the coating demonstrates a flow and levelling performance visual rating of 8 or more on a scale of 1-10 with 10 being perfect flow and levelling as indicated by a smooth, defect-free film.

44. The coated substrate of claim 40, wherein the coating demonstrates a chemical resistance rating against hand sanitizer of 2 or more.

45. The coated substrate of claim 40, wherein the coating demonstrates a chemical resistance rating against a quat cleaner of 3 or more.

46. The coated substrate of claim 40, wherein the coating demonstrates a chemical resistance rating against a neutral cleaner of 4 or more.
